(19) United States
(12) Patent Application Publication
(10) Pub. No.: US 2014/0191902 A1
(43) Pub. Date: Jul. 10, 2014

(54) GOLF INFORMATION PROVIDING APPARATUS AND GOLF REVIEWING SYSTEM

(71) Applicant: Juno Kim, Seoul (KR)

(72) Inventor: Juno Kim, Seoul (KR)

(73) Assignee: U-COMM. TECHMOLOGY INC., Anyang-si (KR)

(21) Appl. No.: 14/234,739

(22) PCT Filed: Jun. 7, 2011
(86) PCT No.: PCT/KR2011/004151

§ 371 Date: Jan. 24, 2014

(30) Foreign Application Priority Data
Jun. 14, 2010 (KR) 10-2010-0056122

(51) Int. Cl. A63B 71/06; G01S 19/19

(52) U.S. Cl. CPC A63B 71/0622; G01S 19/19
USPC 342/357.57

(57) ABSTRACT

A golf information service device of the present invention includes: a case that accommodates components and a battery supplying power to the components; a GPS module that generates position information, using satellite signals; a storing unit that stores golf course information including hole information and target information; a distance calculator that extracts a hole corresponding to the position information in accordance with first input through an operation button, using the position information and the golf course information, and calculates the distance from the current location of the found-out hole to a target; and a distance guide that lets a user know the calculated distance only by a voice. Therefore, it is possible to downsize a device for providing various pieces of golf-related information.

### BACKGROUND OF THE INVENTION

(a) Field of the Invention

The present invention relates to a golf information service device and a golf reconstruction system. More particularly, the present invention relates to a golf information service device which can provide the distance information from the current position to a target in a hole and a golf reconstruction system which can reconstruct the process of a play after the play.

(b) Description of the Related Art

Recently, golf has settled as a sport that ordinary people enjoy due to a tendency of popularization such as variation of hobbies, improvement in life, and activation of social gathering. However, golf is considered as a game that beginners have difficulty in learning and such an understanding can be explained with the following reasons.

First, golf clubs have many courses from nine holes to eighteen holes and have many different geographical features (holes are classified into par-3 holes, par-4 holes, and par-5 holes etc, but the distances from the tee boxes to holes are different and hazards such as bunkers, ponds, roughs are randomly distributed in different ways).

Second, it is usually difficult for ordinary people to make an accurate estimate of a distance over 100 m and the bending made by the grounds of golf courses makes the estimation difficult. Further, there are few experienced caddies and it is difficult to obtain useful advice from unskillful caddies.

Third, it is required to repeat training for a long period of time in order to obtain shot senses for various clubs.

Fourth, golf is a precise event of sports which requires keen senses and mental concentration in comparison to other games.

Accordingly, shot practices based on the sense of distance is important and a habit of always recognizing and checking objective distance data when practicing in various golf courses is important in order to improve golf ability. Golf trainees usually receive the aid of golf instructors and experienced caddies to estimate distances, but it is troublesome for them to ask for their help every time, and there are necessarily limits in estimation of distances based on experiential senses, even if it is accurate.

Products of measuring distances for golf practice have been developed to solve these problems, and for example, there are a distance measurer using a laser, a scope-typed distance measurer, and a physical distance estimator using wheels.

However, the distance measurer using a laser is a little accurate with small errors, but the operation is complicated and the price is high, while the scope-typed distance measurer with a scale in a telescope is low in prices, but it is low in precision and difficult to carry. Further, the distance measurer using wheels can measure only short distances for putting, so the use is limited.

### SUMMARY OF THE INVENTION

The present invention has been made in an effort to provide a golf information service device which can provide the distance information from the current position to a target in a hole and a golf reconstruction system which can reconstruct the process of a play after the play.

An exemplary embodiment of the present invention provides a golf information service device including: a case that accommodates components and a battery supplying power to the components; a GPS module that generates position information, using satellite signals; a storing unit that stores golf course information including hole information and target information; a distance calculator that extracts a hole corresponding to the position information in accordance with first input through an operation button, using the position information and the golf course information, and calculates the distance from the current location of the found-out hole to a hole; and a distance guide that lets a user know the calculated distance only by a voice.

At least the bottom of the case may be made of a material attracted by a magnet and may be made flat.

The operation button may include a main button at the center on the top of the case and two volume buttons on the side or the top of the case. The main button may protrude from the top of the case.

A clip portion that is fastened to a visor may be formed on the bottom of the case.

The operation button may be a shock sensor that senses a predetermined level or more of shock and the case may be disposed in a shoe.

An LED that is turned on at least with the operation of the distance calculator may be further disposed on the top or the side of the case.

The distance calculator may further calculate the height difference between the current location and the target and the distance guide may let a user know the height difference.

A 2-directional level may be disposed on the top of the case.

The device may further include: an inclination sensor that senses the inclination of the case; and an inclination indicator that includes a plurality of LEDs disposed with regular intervals around the edge of the top or the side of the case and makes the LED at the inclined position blink individually from other LEDs in accordance with the sensed inclination.

The GPS module may further generate time information, and the storing unit may store the location information and the time information which are generated at the point of time of second input and may further include an external interface the stored location information and time information to a terminal that displays a digital map.

The storing unit may further store a reconstruction program that makes the terminal extract the map of the hole from a digital map and display the transmitted location information and time information on the extracted map, and the external interface may further transmit the reconstruction program to the terminal.

The reconstruction program may make the terminal further display connection lines that connect the location information on the map in accordance with the order of time series of the pieces of time information.

The external interface may include a USB connector that is taken into/out of the case and is inserted to a USB port on the terminal.

Another embodiment of the present invention provides a golf reconstruction system including: a golf information service unit that stores the location information and the time information at a point of time requested by a user in a hole of a golf course; and a terminal that receives the stored location information and time information, extracts the map of the hole including the location information from a digital map, and displays at least the location information of the location information and the time information on the extracted map.

The terminal may further display connection lines that connect the location information on the map in accordance with the order of time series of the pieces of time information.

Yet another embodiment of the present invention provides a golf information service device including: a GPS module that generates location information and time information, using satellite signals; a storing unit that stores the location information and the time information in accordance with second input through an operation button in a hole of a golf course; and an external interface that transmits the stored location information and time information to a terminal.

The storing unit may further store golf course information including hole information and target information, and may not store the location information and the time information, when the location information at the point of time of the second input does not correspond to the hole information.

When the location information at the point of time of the second input is in a predetermined range of the hole information, the location information and the time information may be stored.

The storing unit may further store golf course information including hole information and target information, and the device may further include: a distance calculator that extracts a hole corresponding to the position information in accordance with first input through an operation button, using the position information and the golf course information, and calculates the distance from the current location of the found-out hole to a target; and a distance guide that lets a user know the calculated distance.

Yet another embodiment of the present invention provides a golf reconstruction method including: receiving reconstruction information including location information and time information which are generated during golf play in a golf course; extracting the map of a hole including the location information from a digital map transmitted from the outside of a built-in digital map; and displaying at least the location information in the reconstruction information on the extracted map.

Yet another embodiment of the present invention provides a golf reconstruction method including: receiving reconstruction information including location information, time information, and hole information which are generated during golf play in a golf course; extracting the map of a hole corresponding to the hole information from a digital map transmitted from the outside or a built-in digital map; and displaying at least the location information in the reconstruction information on the extracted map.

The method may further include: storing the reconstruction information; and collecting the pieces of stored construction information and displaying the pieces of stored information in a selection list, between the receiving of reconstruction information and the extracting of a map, in which the extracting of a map extracts the map of a hole, using the selected reconstruction information.

The extracting of a hole map may generate a warning message, when there is no map of a hole corresponding to the reconstruction information.

The displaying of the location information may further display connection lines that connect the location information on the map of a hole in accordance with the order of time series of the pieces of time information.

The displaying of the location information may further display the number of total shots in the hole.

The displaying the location information may further calculate carry distances of shots, using the lengths of the connection lines or the location information and may further display the carry distances of shots at least close to the connection lines.

The method may further include receiving par information of a hole that the extracted map shows, before the displaying of the location information, in which the displaying of the location information may calculate a score by comparing the number of total shots with the par information and may further display the par information and the calculated score.

The hole information may be a predetermined code.

The extracting of a hole map may extract the map of a hole corresponding to the code.

As described above, since the golf information service device of the present invention lets a user know distance information, using only a voice, it is possible to considerably reduce the size of the distance guide in comparison to a device equipped with a display unit. Accordingly, it is possible to reduce the size and the weight of the entire device. Therefore, portability is improved and the device can also function as a ball marker.

In particular, since the bottom is made of a material attracted by a magnet and is made flat, the device can be mounted on a mount on a hat, similar to common ball markers, and it is possible to improve visibility as a ball marker and convenience in operation by protruding the operation buttons including the main button.

Further, when a clip portion is formed, the device can be mounted on a visor without a specific mount.

Further, it is possible to provide more accurate distance information and ground information by providing not only the information on the distance difference from a target, but also the information on the height difference and the information on horizontality.

Further, since location information and time information during play are transmitted to a terminal that can display a digital map after golf play, it is possible to accurately reconstruct the result of golf play through the digital map displayed on the terminal.

### BRIEF DESCRIPTION OF THE DRAWINGS

FIG. 1 is a block diagram showing a golf information service device relating to the present invention.

FIG. 2 is a plan view showing the outer shape of the golf information service device relating to the present invention.

FIG. 3 is a side view showing the outer shape of the golf information service device relating to the present invention.

FIG. 4 is a view showing the outer shape of a golf information service device according to another exemplary embodiment of the present invention.

FIG. 5 is a schematic diagram showing a method of mounting the golf information service device relating to the present invention on a visor.

FIG. 6 is a schematic diagram showing that golf plays are reconstructed by the golf information service device relating to the present invention.

FIG. 8 is a schematic diagram showing golf plays reconstructed on a terminal receiving position information and time information from the golf information service device relating to the present invention.

FIG. 8 is a block diagram showing a golf reconstruction system relating to the present invention.

FIG. 9 is a block diagram showing a golf reconstruction terminal relating to the present invention.

FIG. 10 is a flowchart illustrating a golf reconstruction method relating to the present invention.

FIG. 11 is a flowchart illustrating another exemplary embodiment of the golf reconstruction method relating to the present invention.

### DETAILED DESCRIPTION OF THE EMBODIMENTS

Hereinafter, a golf information service device and a golf reconstruction system relating to the present invention will be described in detail with reference to the drawings.

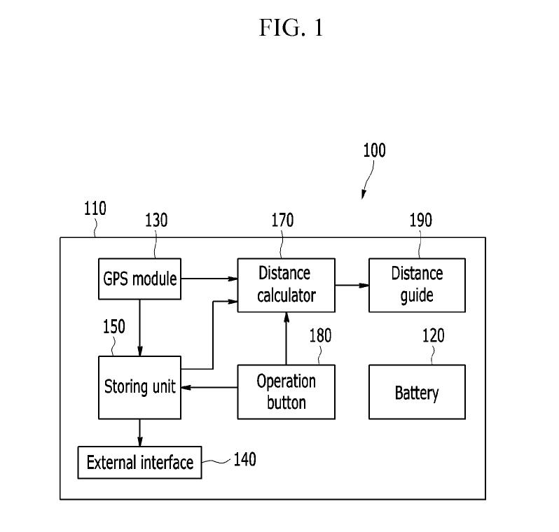

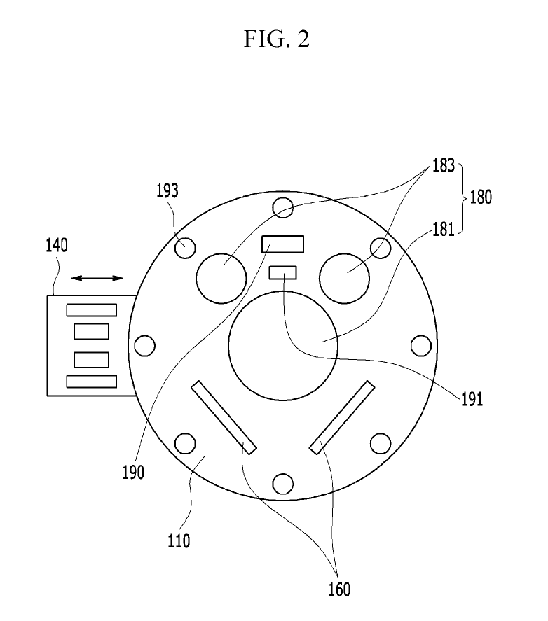

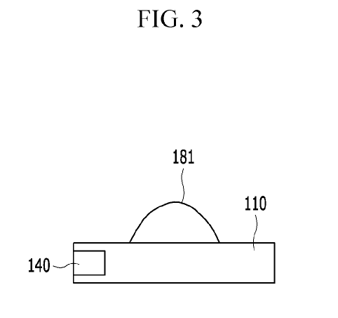

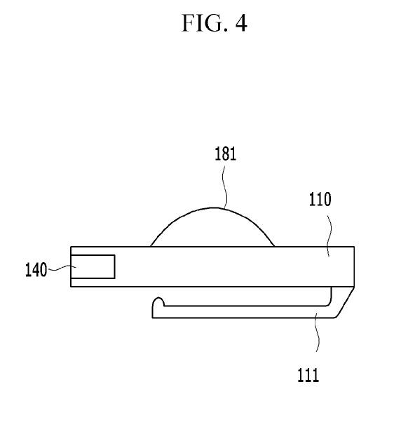

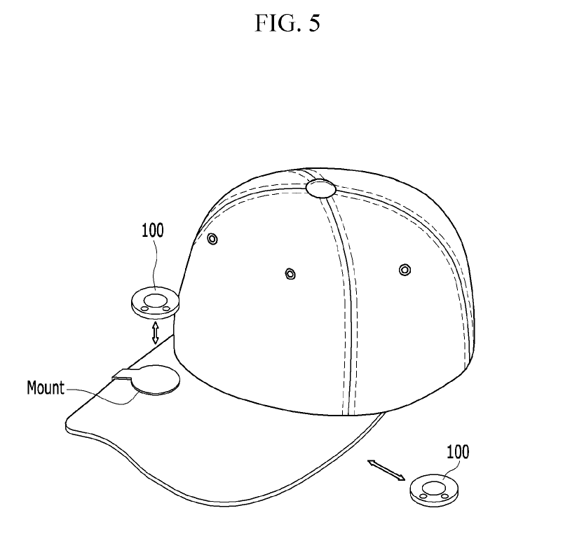

FIG. 1 is a block diagram showing a golf information service device relating to the present invention, FIG. 2 is a plan view showing the outer shape of the golf information service device relating to the present invention, FIG. 3 is a side view showing the outer shape of the golf information service device relating to the present invention, and FIG. 4 is a view showing the outer shape of a golf information service device according to another exemplary embodiment of the present invention. FIG. 5 is a schematic diagram showing a method of mounting the golf information service device relating to the present invention on a visor.

A golf information service device 100 shown in FIGS. 1 to 4 includes a case 110 that accommodates components and a battery 120 supplying power to the components, a GPS module 130 that generates position information, using satellite signals, a storing unit 150 that stores golf course information including hole information and target information, a distance calculator 170 that extracts a hole corresponding to the position information in accordance with first input through an operation button 180, using the position information and the golf course information, and calculates the distance from the current location of the found-out hole to a target, and a distance guide 190 that lets a user know the calculated distance only by a voice.

The case 110, a component forming the outer shape of the golf information service device, accommodates the components such as the GPS module 130, the storing unit 150, the distance calculator 170, the operation button 180, the distance guide 190, and the battery 120. The case may be made of various materials in various shapes and it is preferable that the case is formed as small as possible, as long as the components can be accommodated.

A 2-directional level 160 may be formed on the top of the case. The 2-directional level makes it possible to check the degree of inclination of where the case is placed, using two straight levels crossing each other.

However, when the case is small, the 2-directional level is also small to fit to the size of the case, so the user may have difficulty in looking at the scale (oil drops etc.) of the 2-directional level. Therefore, it may be possible to provide the information on inclination, using blinking of an LED that is small but can be shown.

To this end, the device may further include an inclination sensor (not shown) that senses the inclination of the case and an inclination indicator 193 including an LED that blinks appropriately in accordance with the sensed inclination. The inclination sensor may be a common inclination sensor or a gyro sensor. To indicate inclination by blinking, the inclination indicator includes a plurality of LEDs disposed with regular intervals around the edge of the top or the side of the case and can make the LED at the inclined position blink individually from other LEDs in accordance with the sensed inclination. For example, when eight LEDs are disposed at each 45 degrees (eight directions) and the left upper portion inclines downward in FIG. 2, the left upper LED blinks with a short first period, the upper and the left LEDs blink with a second period longer than the first period, and the right upper and left lower LEDs blink with a third period longer than the second period, thereby indicating the inclination in this way. When the inclination is large, the periods of showing the inclination may be shorter. That is, the degree of inclination can be shown by the periods of blinking.

The 2-directional level may not be provided, when inclination information is provided by blinking of LEDs.

Further, an LED 191 that is turned on at least with the operation of the distance calculator may be disposed on the top or the side of the case. The LED may be used to show whether the golf information service device normally operates. Further, the LED can improve visibility when used as a ball marker by keeping turned on while the golf information service device operates.

The battery 120 is a component supplying power to other components except for the case. By including the battery, the golf information service device has independency without being physically connected with other devices, resulting in portability. The battery may be connected with a terminal through an external interface to be described below and charged, or may be charged by a solar cell additionally mounted on the case.

The GPS (Global Position System) module 130 includes a GPS receiver, a component that generates location information, using satellite signals. In detail, four or more satellites are required to obtain four variables of x, y, z, and t and another satellite may be used for correction signals. Further, the accurate time information can be additionally obtained.

Golf course information including hole information and target information is stored on the storing unit 150.

The hole information shows the information on the range of the hole in each golf course. In detail, a hole is divided into four sections of a teeing ground that is the first section of the hole to play, a green of very closely trimmed grass for putting, hazards that are natural obstacle areas such as bunkers, sea, ponds, rivers, woods, and forests which make smooth play difficult, and a through the green that is the other section except for the three sections, including fairways and roughs, and the hole information includes the information on the ranges of the sections.

The target information shows the location of a target of which the distance is to be measured. The target that a user generally wants to measure the distance would be the cup on the green. Accordingly, it is preferable that the target information is the information on the location of the cup, but it may be difficult to provide the exact location of the cup, considering the fact that the location of the cup on the green frequently changes. Therefore, the locations of parts of greens that are not changed unless there is a specific situation after a golf course is constructed may be targets. In this case, predetermined points inside or on the edge of a green may be targets. Consequently, the target information may be the information on the location of a cup or the information on the location of a predetermined point.

The hole information and the target information should be prepared in advance by a GPS or the like.

The distance calculator 170 calculates the distance from a user to a target. To this end, the location (current location) of the user and the location of the target should be known. The location information generated by the GPS module is used for the location of the user and the target information is used for the location of the target. There is only one item of location information generated by the GPS module, that is, the location of the user at one point of time, but there is a plurality of pieces of target information in accordance with the number of golf courses and the number of holes. The distance to a target that the user wants is the distance to a target in the hole of the golf course where the user is playing. It is required to find out the golf course and the hole where the user is playing in order to satisfy the demand of the user and the hole information is used in this case.

The distance calculator finds out first which hole's range the location information pertains to, using the hole information and the location information generated by the GPS module. When finding out the hole to which the location information pertains, the distance calculator calculates the distance to the target in the hole. As a result, the distance calculator extracts a hole corresponding to the location information (from the location information and the hole information), using the location information and the golf course information and calculates the distance from the current location to the target in the extracted hole (using the location information and the target information).

The calculation of a distance performed by the distance calculator may be made in real time. The distance calculation may be made by selection of the user in consideration of the fact that the time requiring distance calculation is limited to several numbers of times and the power consumption in playing golf. The user's selection is made by operating an operation button on the case and the input through the operation button requesting distance calculation is called first input.

The distance calculator may additionally calculate the height difference between the current location and the target. The information on the current location is generated by the GPS module and may include the altitude. If an altitude difference is additionally stored in the target information of the golf course information, the distance calculator may calculate the height difference between the current location and the target, using the two altitude differences. The calculated height difference helps to a play, similar to the distance to the target.

The operation button 180 may include, for example, a main button 181 at the center on the top of the case and two volume buttons 183 on the side or the top of the case. The main button is a button for requesting distance calculation and the buttons are buttons for adjusting the volume of voice output. The first input may be the action of pressing the main button once.

The distance guide 190 provides the user with the distance from the current location to the target, which is calculated by the distance calculator, in order that the user knows it (providing a height difference in some cases). Typically, there are visually indicating devices using an LCD etc. and those visually indicating devices require a screen of a predetermined size or more for users to be able to see it, so they limit downsizing of the case. In order to solve this problem, the distance guide of the present exemplary embodiment provides the calculated distance, using only a voice. Accordingly, the distance guide includes only a voice output unit such as a speaker. Speakers make the configuration very smaller than LCDs, so downsizing is possible. Further, power consumption is relatively smaller than that of LCDs, such that speakers can be used for a long time with a battery having the same capacity, and when they are set to be used for the same time, a battery having small capacity can be used. Using a battery having small capacity contributes to improving productivity and reducing the size and the weight by decreasing the size, weight, and price of a battery.

When the size and the weight are reduced, the device can be used for other purposes than the distance calculation by changing the external shape of the case. For example, when the bottom of the case is made of a material attracted by a magnet and is made flat, the golf information service device may have the function of a ball marker. Ball markers usually have the shape of coins, but they may be replaced by other objects such as a tee, so the shape is not limited. However, when a mount where a ball marker can be mounted is used, the mount itself can be used by satisfying some conditions of the ball marker. For example, a mount that is fastened to a visor is a magnetic flat plate. In order to be mounted on such a mount, at least the side to be mounted should be flat and made of a material attracted by a magnet. Accordingly, when at least the bottom of the case is made of a material that is attracted by a magnet and is made flat, the mount itself can be used. Although the size of the mount should be considered, the device can be reduced in size such that the mount can be used, through the distance guide that can output only a voice. An example is shown in FIG. 5.

When the device is used as a ball marker, it is possible to improve visibility on the field, using the shape of the operation button. For example, when there are one main button and two volume buttons, as described above, the device can be made easily visible by protruding the main button from the top of the case.

Further, it is possible to improve the possibility of recognition through the sense of touch by protruding the operation button from the case, such that it is possible to operate the operation button even without looking at the device. Accordingly, the device mounted on a visor can be used, as it is.

Further, it is possible to improve portability without a limit in the shape and material of the bottom of the case. For example, when a clip portion 111 that can be fastened to a visor is formed on the bottom of the case, as shown in FIG. 4, the device can be easily carried without a specific mount. As shown in FIG. 5, this is because it is possible to mount the golf information service device directly on a visor, using the clip portion.

Further, the golf information device may be inserted in a hat. In this case, the operation button would protrude out of the hat. The operation button may be provided as a voice sensor and it is useful, especially when the golf information service device is inserted in a hat. This is because the golf information service device can be used to make a specific sound with the hat on a user.

Further, the device may be mounted on equipment other than hats. For example, the device can be mounted in or on a shoe. When the device is mounted in or on a shoe, it may be inconvenienced to operate the operation button by bending over. Accordingly, it is preferable to make input by beating a shoe on the ground with a predetermined force or at a predetermined number of times, and to this end, the operation button may be a shock sensor that senses a predetermined level or more of shock. When the operation button is composed of a main button and a volume button, the main button may be replaced by a shock sensor. When the operation button is replaced by a shock sensor, it is possible to operate the shock sensor by shaking it with a hand.

According to this configuration described above, a user is provided with the current location, the distance to a target, the height difference, and the degree of inclination at the current location, which are helpful for playing golf. In addition, it is possible to provide reconstruting golf play after the play.

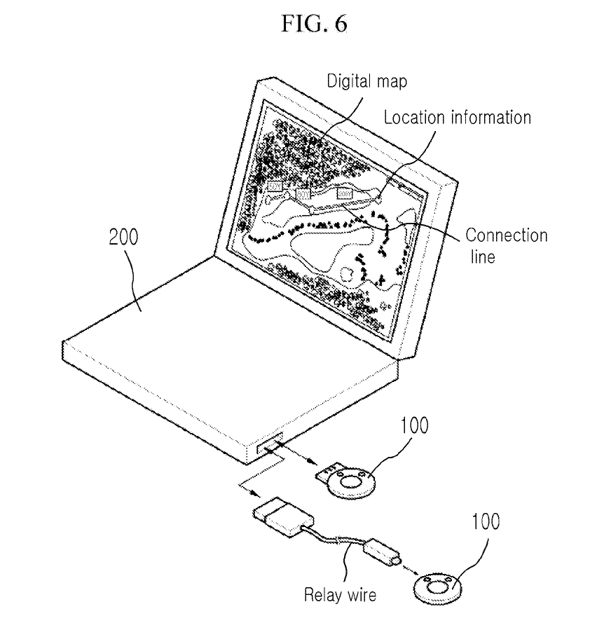

FIG. 6 is a schematic diagram showing that a golf play is reconstructed by the golf information service device relating to the present invention.

Reconstruction needs location information at predetermined times, so time information is additionally required. The time information is generated by the GPS module 130 and the storing unit 50 stores the location information and the time information generated when second input is made through the operation button. The second input is an instruction of storing the location information and the time information at a predetermined point of time for reconstruction, and for example, it may be an action of pressing the main button twice within a predetermined time. In this case, when the main button is pressed twice at each shot point in a hole, the location information and the time information at the shot point is stored in the storing unit. Reconstruction is made by arranging the stored location information in the order of time of the time information. Since checking through a visual display unit is required in the reconstruction, it is required to transmit the location information and the time information stored in the storing unit to a terminal 200 with a visual display unit.

If only the location information is displayed on a terminal, the displayed location information would have meaning. In order for the location information to have a meaning, corresponding location information should be displayed on the map of the hole. To this end, the terminal is required to be able to visually display a digital map including the map of the hole. The case is equipped with an external interface 140 to transmit location information and time information to the terminal. The external interface may be a USB connector that can be taken into/out of the case and is inserted to a USB port on the terminal. Obviously, the external interface may be a USB port where one connector of a relay wire, which relays information between the golf information service device and the terminal, can be inserted.

Since the terminal receives only location information and time information through the external interface, it doesn't know whether to have to display the information to correspond to the digital map. Accordingly, it is possible to enable the terminal to appropriately operate by storing a reconstruction program, which makes the terminal extract the map of a hole from a digital map and display the transmitted location information and time information on the extracted map, on the storing unit and by transmitting the reconstruction program stored on the storing unit to the terminal through the external interface. The map of a hole extracted from the digital map is the map of a hole which includes the location information transmitted from the golf information service device.

The reconstruction program may make the terminal not display detailed time formation, for example, ‘00 hr 00 min, XXday YYmonth, XXyr’, when making it display location information on the map of a hole. In this case, it is difficult to know the progress of play only from the pieces of location information shown by points, such that the reconstruction program may make the terminal display connection lines that connect the location information on the map of a hole in accordance with the order of time series of the pieces of time information. This is exemplified in FIG. 7.

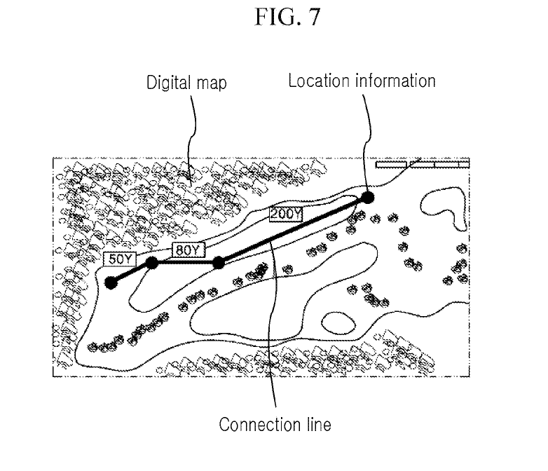

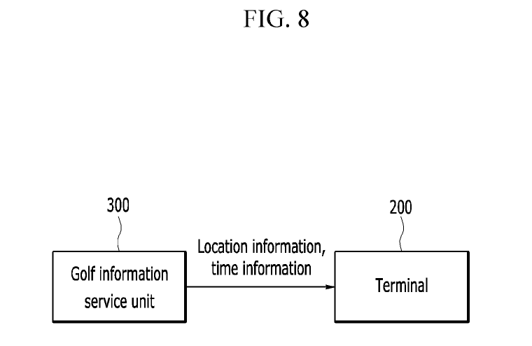

FIG. 8 is a schematic diagram showing golf play reconstructed on a terminal receiving position information and time information from the golf information service device relating to the present invention. FIG. 7 shows an example of a display screen of a terminal, in which a digital map, in detail, the map of a hole is displayed on the background and pieces of location information are displayed on the map of a hole. Further, the pieces of location information are connected by connection lines on the basis of the time information.

In order to reconstruction golf play in this way, an appropriate terminal is needed in addition to the golf information service device. Further, if it is only for reconstructing golf play, some components of the golf information service device may not be provided. Further, a terminal may receive a reconstruction program from other unit than the golf information service device or may have a built-in reconstruction program. In this case, the golf information service program does not need to store a reconstruction program on a storing unit.

FIG. 8 is a block diagram showing a golf reconstruction system relating to the present invention.

The golf reconstruction system shown in FIG. 8 includes a golf information service unit 300 that stores the location information and the time information at a point of time requested by a user in a hole of a golf course and a terminal 200 that receives the stored location information and time information, extracts the map of the hole including the location information from a digital map, and displays at least the location information of the location information and the time information on the extracted map.

The golf information service unit 300 stores the location information and the time information at a point of time requested by a user in a hole of a golf course. The golf information service unit may be used for purposes other than reconstructing golf play, for example, for providing the distance to a target, a height difference, and the degree of inclination and the configuration for those purposes may be made the same as that of the golf information service device described above. In detail, the golf information service unit may further have golf course information including hole information and target information on a storing unit and may further include a distance calculator 170 that extracts a hole corresponding to location information, using location information and golf course information, in accordance with first input and calculates the distance from the current location to a target in a hole and a distance guide 190 that lets a user know the calculated distance.

The information stored in the golf information service unit is location information and time information. The location information and the time information may be generated by the golf information service unit itself or may be received from the outside. The golf information service unit may include a built-in GPS module to generate the location information and the time information. The golf information service unit can generated location information and time information anywhere, using the GPS module, and if reconstruction is performed by using location information and time information which are randomly stored, normal reconstruction cannot be achieved. Therefore, the location information and the time information stored in the golf information service unit should be ones obtained in holes of a golf course. To this end, the golf information service unit may include a unit that stores golf course information and a unit that determines whether location information to be stored is in the ranges of holes, using the golf course information. Further, it may include an external interface that transmits the stored location information and time information to a terminal.

That is, when generating location information and time information by itself, the golf information service unit may include a GPS module, a storing unit, and an external interface.

Compared with the configuration of the golf information service device described with reference to FIG. 1, the golf information service unit includes a GPS module that generates location information and time information, using satellite signals, a storing unit 150 that stores the location information and the time information in accordance with second input through an operation button in a hole of a golf course, and an external interface 140 that transmits the stored location information and time information to a terminal.

The storing unit further stores golf course information including hole information and target information, and may not store location information and time information, when the location information at the point of time of the second input does not correspond to the hole information. The fact that they do not correspond to each other means that the location information at the point of time of the second input is out of the range of predetermined hole information. A display unit that lets a user know this situation may be provided and it may be integrally formed with the distance guide shown in FIG. 1. A voice message such as ‘it is not an effective location’ may be outputted through the distance guide.

A user may want to reconstruct movement paths in a golf course in addition to the golf play itself. To this end, when the location information at the point of time of the second input is in a predetermined range of the hole information, the location information and the time information can be stored. However, the predetermined range should not be over the range of the golf course.

The terminal 200 receives the location information and the time information from the golf information service unit and displays the location information on the map of the hole. To this end, the terminal should have a built-in digital map including the map of the hole or should be able to receive it from the outside. Further, the terminal should extract the map of the hole including the location information from the digital map. Reconstructing is finished by displaying the location information and the time information on the extracted map. Connection lines connecting the pieces of information location may be displayed for a user to easily know the flow of the path of action, in which the time information may not be displayed. This is because the connection lines connect the pieces of location information displayed on the map in the order of time series of the time information, so the user can know the flow of the golf play even though detailed time information is not displayed.

The terminal is described hereafter in detail.

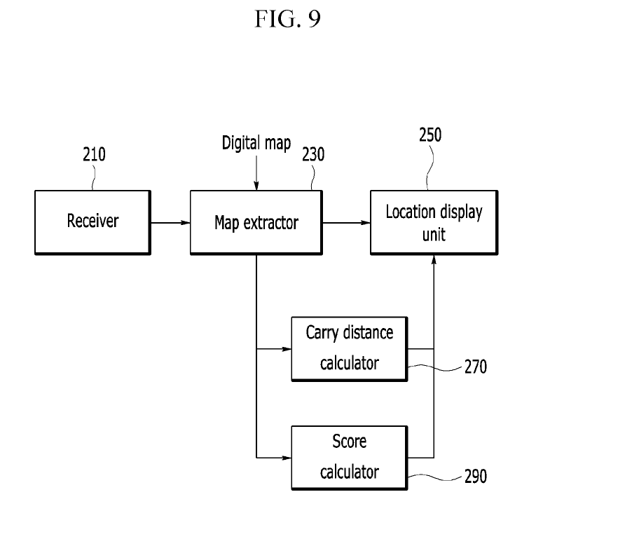

FIG. 9 is a block diagram showing a golf reconstruction terminal relating to the present invention, in which the golf reconstruction terminal may be the terminal described above.

The golf reconstruction terminal shown in FIG. 9 includes a receiver 210 that receives location information and time information generated at a predetermined point of time in a hole of a golf course, a map extractor 230 that extracts a map of the hole including the location information from a digital map transmitted from the outside of a built-in digital map, and a location display unit 250 that displays at least the location information of the time information and the location information.

The receiver 210 receives location information and time information. The location information and time information are supposed to be ones generated at a predetermined point of time in a hole of a golf course, but the receiver cannot know that. However, the location information and time information transmitted from the golf information service unit described above may be ones generated in a hole of a golf course.

When the golf information service unit that transmits location information and time information does not include hole information or it does not transmit hole information even if it includes the hole information, it is required to check whether the location information and time information are ones generated in a hole of a golf course. Obviously, even though the pieces of information are ones transmitted from the golf information service unit, there may be errors; therefore, it wouldn't matter to check them again. The map extractor 230 is used in the checking. When there is no built-in digital map, the receiver receives a digital map, for example, from a digital map service server.

The map extractor 230 extracts the map of the hole including the location information from the digital map. The digital map may be one transmitted from the outside or a built-in one. The map of the hole extracted by the map extractor is supposed to be not a map showing a portion of the hole including the location information, but a map showing the entire hole to fit in with the purpose of reconstructing golf play.

To this end, the digital map service server can store maps showing entire holes, for example, maps like pictures and transmit the map showing the entire hole including the location information to the receiver. The map extractor requests the map service server to transmit the map showing the entire hole including the location information and receives it through the receiver, thereby finishing extracting the map of the hole. Further, the map extractor may store map coordinates of holes in advance, extract the hole including the location information, using the stored map coordinates, and request the map service server to transmit the map showing the entire extracted hole. The former is for when the hole including the location information of a plurality of holes is extracted from the digital map service server and the latter is for when the hole is extracted from the golf reconstruction terminal. For example, when 10th hole of a golf course A is selected from the digital map service server and the map showing the entire 10th hole of the golf course A is provided, it is possible to extract and provide the map showing the entire hole which includes the location information (on which the location information is displayed) by the service of the digital map service server only by finding out the hole including the location information. In any case, map coordinates should be included in the map showing the entire hole which is transmitted from the digital map service server in order to display the location information over an appropriate position on the map showing the entire hole. The map coordinates may be the coordinates of two apexes on a diagonal line, for example, when rectangular map showing the entire hole is provided. For the features of a rectangle, when the coordinates of two apexes on a diagonal line are known, it is possible to find out the coordinates of the other two apexes, such that it is possible to construct kinds of vertical and horizontal axes, using the coordinates of the apexes. It is possible to display the location information over an appropriate position on the map showing the entire hole by settling the latitude and the longitude included in the location information on the vertical axis and the horizontal axis, respectively. Displaying the location information over the position is made by the location display unit 250. Further, the map coordinates may be used also to extract the hole including the location information. This process is executed by a processing routine that checks whether predetermined coordinates are inside the map coordinates.

It was described above that the digital map service server stores the maps of all of the entire holes including the map coordinates, but the digital map service server may store common maps such as the google map and the google earth. If it is possible to show holes in the form of pictures when enlarging maps, it is possible to extract maps of holes and display location information, even using common maps. For example, the map extractor can extract the map of a hole by transmitting location information to the digital map service server and requesting the digital map service server to transmit a common map with a predetermine scale which shows the area around the corresponding point. The digital map service server transmits the map with a predetermined scale, which is obtained from a common map, showing the area around the point corresponding to the location information, to the receiver and the user can check the map showing the entire hole by appropriately adjusting the scale. However, when a digital map service server storing common maps is used, even maps of other areas than the areas shown by the map of the hole are objects to be extracted. Accordingly, for normal reconstruction of golf play, it is preferable that the map extractor checks whether the location information is included in the map coordinates of a predetermined hole, and transmits the location information to the digital map service server only when the location information is included in the map coordinates of the predetermined hole.

When there is a built-in digital map, the map extractor extracts the map of a hole including the location information, using the map coordinates. The digital map may be one transmitted to the receiver from a digital map service server and stored therein. Obviously, the map coordinates for each map of holes are supposed to be set in the built-in map too.

Since the map extract is a component that extracts the map of the hole including the location information from the digital map, it cannot normally extract the map of a hole, when the location information is generated outside the holes of a golf course. In this case, a warning message may be displayed.

If the map of a hole is normally extracted, the map of the hole and the location information are displayed by the location display unit 250. The location display unit is supposed to be a visual display unit such as an LCD to display the maps of holes and location information.

Further, the location display unit may further display connection lines that connect location information displayed on the map of a hole in the order of time series of the location information. It is possible to easily know the movement path of a golf ball by displaying the connection lines.

Further, the location display unit can display not only location information, time information, and connection lines, but also additional information such as the number of total shots, the carry distances of shots, and scores. The additional information is divisionally provided for each hole and the number of total shots depends on the number of pieces of location information included in each hole.

The number of total shots determined as described above can also be displayed on the map of the hole or on a margin except for the region where the map of the hole is displayed.

The carry distances of shots are calculated by converting the lengths of the connection lines on the map into real distances, using the scale of the map. The lengths of the connection lines may be calculated from the location information, because they are the distances between the pieces of location information on the map. The calculation of the carry distances is performed by a carry distance calculator 270 and the calculated carry distances may be displayed close to the corresponding connection lines by the location display unit, as shown in FIG. 7. Carry distances are displayed close to the connection lines, like ‘200Y’, ‘80Y’, and ‘50Y’. Displaying corresponding carry distances close to connection lines can improve the reconstruction efficiency. Obviously, the carry distances of shots may be displayed in other regions, not close to the connection lines, for example, in the margin where the number of total shots is displayed. The carry distances are supposed to be displayed in accordance with the order of time series. Further, symbols such as ‘(1)’, ‘(2)’, ‘(3)’, . . . showing shots may be displayed together.

Further, the location display unit can improve the reconstruction efficiency by displaying scores such as ‘par’, ‘birdie’, and ‘eagle’. There is a need of knowing the par information of a hole first in order to provide scores. The par information is received by the receiver and the received par information is supposed to be in connection with the hole that a map extracted by the map extractor shows. The par information may be transmitted from a golf information service unit or a digital map.

It is possible to calculate a score by comparing the transmitted par information with the number of total shots described above and the calculation of a score is made by a score calculator 290. The score calculated by the score calculator is displayed by the location display unit and the par information may be displayed together.

As a result, the location display unit can display the number of total shots, carry distance of shots, and scores, as follows, on a margin, for example, on the right margin of the region where a hole map of FIG. 7 is displayed.

Hole: Par 4 hot: 4 times 1 200Y 2 80Y 3 50Y 4 2Y

Score: Even

Driver average carry distance: 236Y

The connection line showing 2Y of the fourth shot may not be shown by being covered by the location information of the fourth shot on the map, and particularly in this case, it is significant to display the carry distances of shots on a margin. The driver average carry distance may be calculated by the carry distance calculator, using only the first shot for each shot. Obviously, to this end, there is a need of a storing unit that stores the carry distance of the first shot for each hole. Further, the carry distance calculator is supposed to be able to find the average. For a par-3 hole, the first shot may be made without a driver, so the carry distance of the first shot in the par-3 hole may not be stored, or if stored, it may be excluded in calculation of average.

Various pieces of information other than the driver average carry distance can be provided. For example, it is possible to provide the accuracy of putting/the average number of times of putting, using the number of shots on the green.

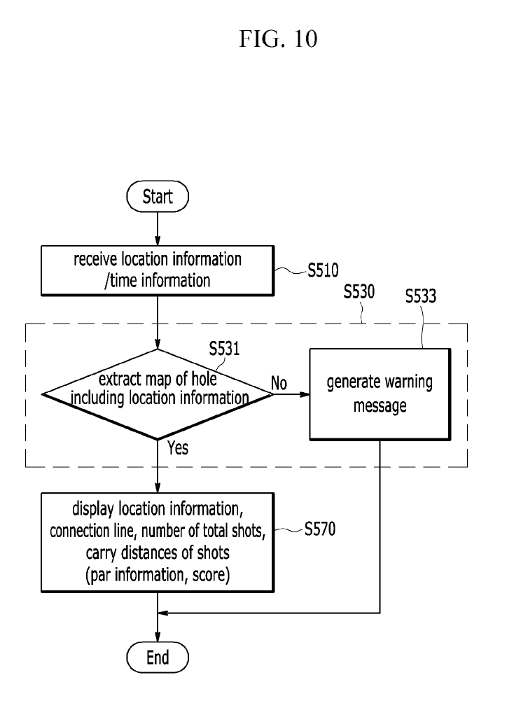

FIG. 10 is a flowchart illustrating a golf reconstruction method relating to the present invention and the method may be explained through the operation of the golf reconstruction terminal described above.

First, reconstruction information including location information and time information generated at a predetermined point of time in a hole of a golf course is received (S510). This process is performed by the receiver of a golf reconstruction terminal.

Next, the map of a hole including the location information is extracted from a digital map transmitted from the outside or a built-in digital map (S530). When the map of a hole is normally extracted by the map extractor (S531), a step of displaying various pieces of golf information is performed, or when there is no map of a hole including the location information, a warning message is generated (S533).

When the map of a hole including the location information is extracted, the location information is displayed at the corresponding coordinates on the extracted map (S570). Whether to display time information may be selective. In particular, when connection lines connecting pieces of location information are displayed in accordance with the order of time series of the time information, the time information may not be displayed. Various pieces of golf play information such as the number of total shots, the carry distances of shots, the par information, and scores may be displayed together with the location information. The carry distance calculator is used to calculate the carry distances of shots and the calculated carry distances may be displayed close to corresponding connection lines.

It is required to know the par information in order to display the par information and scores, in which the par information can be received by the receiver. Because the par information is the information about the hole shown by the extracted map, it is supposed to be received between the step of extracting the map of a hole and the step of displaying the location information. When the par information is obtained, the score calculator calculates the score by comparing the number of total shots in the corresponding hole with the par information, and then the par information and the calculated score are displayed.

The golf reconstruction method when receiving reconstruction information including location information and time information from a golf information service device was described above, but the golf information service device may include hole information for the function of distance calculation. It is possible to easily extracts the map of a corresponding hole by including the hole information in the reconstruction information.

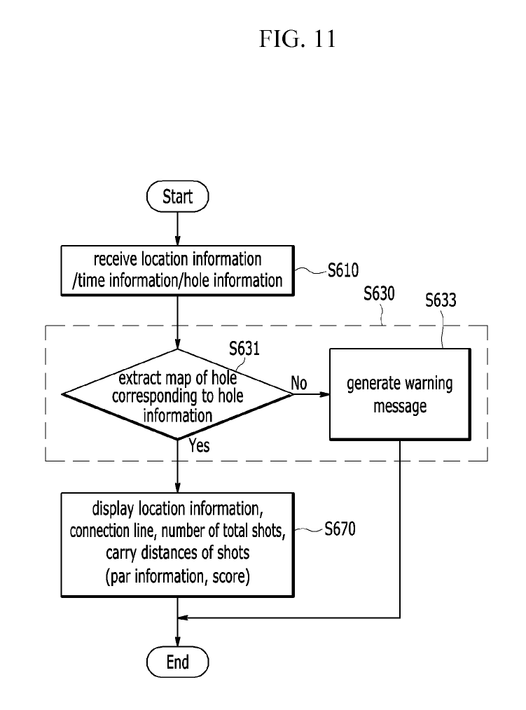

FIG. 11 is a flowchart illustrating another exemplary embodiment of the golf reconstruction method relating to the present invention.

Reconstruction information including location information, time information, and hole information which are generated during golf play in a golf course is received (S610). The hole information other than the location information and the time information is also received. The unit providing location information and time information, for example, a golf information service device is supposed to have hole information too, in order to receive hole information.

Because the hole information shows which hole it is in which golf course, the hole information is used to extract the map of the hole (S630). That is, the map of a hole corresponding to the hole information is extracted from a digital map transmitted from the outside or a built-in digital map (S631), and when there is no map of the corresponding hole, a warning message is generated (S633). A series of ruled symbols that matches hole information with the maps of holes may be used to extract the maps of holes, using the hole information.

For example, a hole b in a golf course A may be designated by an identification number, that is, a code, for example, ‘00103’ so that a unit such as a golf information service device can use coded hole information. In this case, the received hole information is also designated by the code ‘00103’, such that it is possible to easily extract the maps of corresponding holes by giving codes to holes on a digital map.

Reconstruction of golf play is finished by displaying at least the location information in the reconstruction information on the extracted map (S670). Obviously, connection lines, the number of total shots, carry distances, par information, and scores can be additionally displayed.

Golf reconstruction methods when only location information and time information is included in reconstruction information without hole information and when hole information is included in reconstruction information were described above. According to the above description, when reconstruction information transmitted from a unit such as a golf information service device is received, a hole map is extracted and various pieces of golf information such as location information are displayed on the extracted map or on a margin. In this process, it is preferable for user to be able to select reconstruction information.

To this end, the method may further include a step of storing reconstruction information and a step of collecting the pieces of stored construction information and displaying them in a selection list, between the steps of receiving reconstruction information S510 and S610 and the steps of extracting a map S530 and S630. Accordingly, it is possible to provide the user with the selection list and the user can reconstruct the selected reconstruction information, and to this end, the steps of extracting a map S530 and S630 are supposed to extract the map of a hole, using the selected reconstruction information.

On the other hand, the golf reconstruction method described above may be stored as a program on a computer-readable medium.

Those skilled in the art of the present invention would understand that the present invention can be implemented in other detailed configurations without changing the technical spirit of the necessary features. Therefore, it should be understood that the exemplary embodiments described above are only examples and should not be construed as being limitative in all respects. The scope of the present invention is determined not by the above description, but by the following claims, and all of changes or modifications from the spirit, scope, and equivalents of claims should be construed as being included in the scope of the present invention.

For example, the shape of the case of the golf information service device can be changed in various ways, and the positions of the operation buttons and the level can also be freely changed.

Further, the terminal may be a personal computer or a mobile communication terminal equipped with a unit that can receive location information and time information from a digital map and a golf information service device/unit and can display them.

### REFERENCE NUMERALS

100 . . . golf information service device 110 . . . case
111 . . . clip portion 120 . . . battery
130 . . . GPS module 140 . . . external interface
150 . . . storing unit 160 . . . 2-directional level
170 . . . distance calculator 180 . . . operation button
181 . . . main button 183 . . . volume button
190 . . . distance guide 191 . . . LED
193 . . . inclination indicator 200 . . . terminal
210 . . . receiver 230 . . . map extractor
250 . . . location display unit 270 . . . carry distance calculator
290 . . . score calculator 300 . . . golf information service unit

### INDUSTRIAL APPLICABILITY

The present invention can be used for a device that provides golf-related information such as the distance to a target, a height difference, and the degree of inclination in a golf course.

Further, the present invention can be used for a ball marker.

Further, the present invention can be used for a system that reconstructs the process of golf play later.

While this invention has been described in connection with what is presently considered to be practical exemplary embodiments, it is to be understood that the invention is not limited to the disclosed embodiments, but, on the contrary, is intended to cover various modifications and equivalent arrangements included within the spirit and scope of the appended claims.

1. A golf information service device comprising:
a case that accommodates components and a battery supplying power to the components;
a GPS module that generates position information, using satellite signals;
a storing unit that stores golf course information including hole information and target information;
a distance calculator that extracts a hole corresponding to the position information in accordance with first input through an operation button, using the position information and the golf course information, and calculates the distance from the current location of the found-out hole to a target; and
a distance guide that lets a user know the calculated distance only by a voice.

2. The device of claim 1, wherein at least the bottom of the case is made of a material attracted by a magnet and is made flat.

3. The device of claim 2, wherein the operation button includes a main button at the center on the top of the case and two volume buttons on the side or the top of the case.

4. The device of claim 3, wherein the main button protrudes from the top of the case.

5. The device of claim 1, wherein a clip portion that is fastened to a visor is formed on the bottom of the case.

6. The device of claim 1, wherein the operation button is a shock sensor that senses a predetermined level or more of shock and the case is disposed in a shoe.

7. The device of claim 1, wherein an LED that is turned on at least with the operation of the distance calculator is further disposed on the top or the side of the case.

8. The device of claim 1, wherein the distance calculator further calculates the height difference between the current location and the target and the distance guide lets a user know the height difference.

9. The device of claim 1, wherein a 2-directional level is disposed on the top of the case.

10. The device of claim 1, further comprising: an inclination sensor that senses the inclination of the case; and an inclination indicator that includes a plurality of LEDs disposed with regular intervals around the edge of the top or the side of the case and makes the LED at the inclined position blink individually from other LEDs in accordance with the sensed inclination.

11. The device of claim 1, wherein the GPS module further generates time information, and the storing unit stores the location information and the time information which are generated at the point of time of second input and further includes an external interface the stored location information and time information to a terminal that displays a digital map.

12. The device of claim 11, wherein the storing unit further stores a reconstruction program that makes the terminal extract the map of the hole from a digital map and display the transmitted location information and time information on the extracted map, and the external interface further transmits the reconstruction program to the terminal.

13. The device of claim 12, wherein the reconstruction program makes the terminal further display connection lines that connect the location information on the map in accordance with the order of time series of the pieces of time information.

14. The device of claim 11, wherein the external interface includes a USB connector that is taken into/out of the case and is inserted to a USB port on the terminal.

15. A golf reconstruction system comprising: a golf information service unit that stores the location information and the time information at a point of time requested by a user in a hole of a golf course; and a terminal that receives the stored location information and time information, extracts the map of the hole including the location information from a digital map, and displays at least the location information of the location information and the time information on the extracted map.

16. The system of claim 15, wherein the terminal further displays connection lines that connect the location information on the map in accordance with the order of time series of the pieces of time information.

17. A golf information service device comprising: a GPS module that generates location information and time information, using satellite signals; a storing unit that stores the location information and the time information in accordance with second input through an operation button in a hole of a golf course; and an external interface that transmits the stored location information and time information to a terminal.

18. The device of claim 17, wherein the storing unit further stores golf course information including hole information and target information, and does not store the location information and the time information, when the location information at the point of time of the second input does not correspond to the hole information.

19. The device of claim 18, wherein when the location information at the point of time of the second input is in a predetermined range of the hole information, the location information and the time information are stored.

20. The device of claim 17, wherein the storing unit further stores golf course information including hole information and target information, and the device further includes: a distance calculator that extracts a hole corresponding to the position information in accordance with first input through an operation button, using the position information and the golf course information, and calculates the distance from the current location of the found-out hole to a target; and a distance guide that lets a user know the calculated distance.

21. A golf reconstruction method comprising:
receiving reconstruction information including location information and time information which are generated during golf play in a golf course;
extracting the map of a hole including the location information from a digital map transmitted from the outside of a built-in digital map; and
displaying at least the location information in the reconstruction information on the extracted map.

22. A golf reconstruction method comprising:
receiving reconstruction information including location information, time information, and hole information which are generated during golf play in a golf course;
extracting the map of a hole corresponding to the hole information from a digital map transmitted from the outside or a built-in digital map; and
displaying at least the location information in the reconstruction information on the extracted map.

23. The method of claim 21, further comprising: storing the reconstruction information; and collecting the pieces of stored construction information and displaying the pieces of stored information in a selection list, between the receiving of reconstruction information and the extracting of a map, wherein the extracting of a map extracts the map of a hole, using the selected reconstruction information.

24. The method of claim 21, wherein the extracting of a hole map generates a warning message, when there is no map of a hole corresponding to the reconstruction information.

25. The method of claim 21, wherein the displaying of the location information further displays connection lines that connect the location information on the map of a hole in accordance with the order of time series of the pieces of time information.

26. The method of claim 25, wherein the displaying of the location information further displays the number of total shots in the hole.

27. The method of claim 26, wherein the displaying the location information further calculates carry distances of shots, using the lengths of the connection lines or the location information and further displays the carry distances of shots at least close to the connection lines.

28. The method of claim 27, further comprising receiving par information of a hole that the extracted map shows, before the displaying of the location information, wherein the displaying of the location information calculates a score by comparing the number of total shots with the par information and further displays the par information and the calculated score.

29. The method of claim 22, wherein the hole information is a predetermined code and the extracting of a hole map extracts the map of a hole corresponding to the code.

30. A computer-readable recording medium programmed with the reconstruction method of claim 21.
